(19) United States
(12) Patent Application Publication
(10) Pub. No.: US 2026/0189413 A1
(43) Pub. Date: Jul. 2, 2026

(54) ELECTRONIC DEPOSIT BOX FOR DATA PROTECTION AND STORAGE

(71) Applicant: EpositBox, LLC, Boca Raton, FL (US)

(72) Inventor: Jan Michael CARSON, Port Saint Lucie, FL (US)

(21) Appl. No.: 19/548,916

(22) Filed: Feb. 24, 2026

Related U.S. Application Data
(63) Continuation-in-part of application No. 17/706,566, filed on Mar. 28, 2022.
(60) Provisional application No. 63/170,400, filed on Apr. 2, 2021.

(51) Int. Cl. H04L 9/00; G06F 21/60; H04L 9/32

(52) U.S. Cl. CPC H04L 9/50; G06F 21/602; H04L 9/3242

(57) ABSTRACT

An electronic deposit box information handling system (IHS), method and computer program product secure data such as personally identifiable information (PII) with separated dual encryption of each data payload and obscured labeling, providing an electronic deposit box to thwart a data breach. The IHS receives a first tenant data structure tenant record(s) having tenant-hashed tabular label(s) associated with a tenant-encrypted data payload. The IHS appends a hashed tenant identifier tenant record of the first tenant data structure. For each tenant record, the IHS selects an electronic deposit box encryption key of one or more electronic deposit box encryption keys. The IHS over-encrypts the respective tenant-encrypted data payload using the selected electronic deposit box encryption key to produce corresponding one or more secure data records. The IHS stores the one or more secure data records in a secure multiple-tenant data store.

### RELATED APPLICATIONS

This application is based on and claims priority to U.S. Non-Provisional application Ser. No. 17,706,566 filed Mar. 28, 2022, which claims the benefit of priority based on U.S. Provisional Patent Application No. 63/170,400 filed Apr. 2, 2021. The entire contents of the above-referenced applications are expressly incorporated herein by reference.

### TECHNICAL FIELD

The present disclosure relates generally to personal data protection and storage, and more particularly, to a personal data protection and storage as a service using a blockchain as the secure storage object.

### BACKGROUND

Although cash and carry business transactions do occur, frequently businesses receive personal information from customers for making a financial transaction to purchase and a deliver a product or service. In an example, the personal information includes credit, debit or checking account information and personally identifiable information (PII). The business would record the private information along with other details about the financial transaction as part of required bookkeeping and business accounting. Customers may allow a business to have continued access to this private information for preapproved future transactions. Computerized sales technology facilitated the standard commerce practice of retaining all details of a transaction. With increasing reliance on networked and online communications, the customer's billing and financial information, including banking account and credit account information, became a target for thieves who exploited security vulnerabilities. Businesses who failed to prevent theft of customer's private information became liable for the resulting financial damages to the customer. The merchant service business model was birthed by this environment to reduce the vulnerability to data theft and to reduce the liability of the business. A merchant separately handled the financial transaction with the customer for the business that provided the goods or service. The merchant acted a middleman, receiving the banking or credit account information from the customer to perform the financial transaction. The business providing the goods or service had no need to store the private information, and thus risked no liability for any theft of the private information. The merchant service business model for financial information has been almost universally adopted as being attractive to all companies large and small because: (i) liability for credit card fraud was extracted away from the company completely; (ii) the merchant transaction was seamless and did not hinder the sales process; and (iii) the consumer making the purchase felt safer knowing a third-party merchant acted on their behalf to ensure the security and safety of their credit card information.

Although the generally-known merchant service business model has allowed business to outsource financial transactions with customer's financial data, businesses frequently store a large amount of personal data. Personal data, also known as Personally Identifiable Information (PII), is stored by many companies. In addition to customers, the personal data can be from employees, vendors, consultants, third party data collectors that are not handled by the merchant service business model. Companies store PII for many reasons including but not limited to: efficiency of future transactions, grouping customer types related to product types to understand product use, fit and success within identified PII groups, forecasting product adoption in PII groups, developing new products to fit PII groups. According to the General Data Protection Regulation (GDPR) of the European Union, the term personal information is defined as: “Any information related to an identified or identifiable natural person.” Personally identifiable information can include: passwords, usernames, names, email addresses, physical addresses, phone numbers, ages, birthdates, gender, family information, order history, preferences, communication history, emergency contacts, employment information, education, resume' details, geographic and demographic information, religious information, membership information, credit card information, photographs, etc.

Like financial information, PII has become an increasingly valuable target for theft and data hostage threats. Companies are caught in continuous cycles of patching defensive security activities that fail over time with advancing computer ability of large well-funded criminal organizations. Countries and states are intervening to establish protection and compliance measures for the handling of PII to curb fraud. Companies are burdened with compliance requirements for the collection, storage and sharing of PII of multiple governing agencies each with its own interpretation of what is considered compliant. Company exposure to liability and compliance complexity will continue to increase. The consumer is concerned about their PII safety and dispersion across many companies. The present disclosure is aimed at resolving these and other problems present in the prior art.

### SUMMARY

In one aspect of the present disclosure, an information handling system (IHS) includes a network interface, secure memory and a controller. The network interface is communicatively connectable, via a network, to one or more tenant IHS including a first tenant IHS. The first tenant IHS uses a first hashing algorithm that hashes tabular labels and a first encryption algorithm that encrypts data payloads. The secure memory stores an electronic deposit box application, an encryption application, and an encryption key data structure. The controller is communicatively coupled to the network interface and to the secure memory. The controller includes at least one hardware processor that executes the electronic deposit box application to configure the IHS. The controller securely connects, via the network interface, with the first tenant IHS. The controller receives, from the first tenant IHS, a first tenant data structure comprising at least one tenant record. Each tenant record has one or more tenant-hashed tabular labels associated with a tenant-encrypted data payload. The controller appends a first tenant identifier associated with the first tenant to the at least one tenant record of the first tenant data structure. For each tenant record, the controller selects an electronic deposit box encryption key of one or more electronic deposit box encryption keys. The controller over-encrypts the respective tenant-encrypted data payload using the selected electronic deposit box encryption key to produce corresponding one or more secure data records. The controller stores the one or more secure data records in a multiple-tenant data store as a unique tenant node within a blockchain distributed data storage network.

In another aspect of the present disclosure, a method includes securely connecting, via a network interface of an electronic deposit box IHS, with a first tenant IHS. The method includes receiving, from the first tenant IHS, a first tenant data structure comprising at least one tenant record. Each tenant record has one or more tenant-hashed tabular labels associated with a tenant-encrypted data payload. The method includes appending a first tenant identifier associated with the first tenant to the at least one tenant record of the first tenant data structure. For each tenant record, the method includes selecting an electronic deposit box encryption key of one or more electronic deposit box encryption keys. The method includes over-encrypting the respective tenant-encrypted data payload using the selected electronic deposit box encryption key to produce corresponding one or more secure data records. The method includes storing the one or more secure data records in a secure multiple-tenant data store as a unique tenant node within a blockchain distributed data storage network.

In an additional aspect of the present disclosure, a computer program product includes program code on a computer readable storage device. The program code, when executed by a processor associated with an IHS, enables the IHS to provide functionality of securely connecting, via a network interface of an electronic deposit box IHS, with a first tenant IHS. The functionality includes receiving, from the first tenant IHS, a first tenant data structure comprising at least one tenant record, each tenant record having one or more tenant-hashed tabular labels associated with a tenant-encrypted data payload. The method includes appending a first tenant identifier associated with the first tenant to the at least one tenant record of the first tenant data structure. The functionality includes, for each tenant record, selecting an electronic deposit box encryption key of one or more electronic deposit box encryption keys. The functionality includes over-encrypting the respective tenant-encrypted data payload using the selected electronic deposit box encryption key to produce corresponding one or more secure data records. The functionality includes storing the one or more secure data records in a secure multiple-tenant data store as a unique tenant node within a blockchain distributed data storage network.

These and other features are explained more fully in the embodiments illustrated below. It should be understood that in general the features of one embodiment also may be used in combination with features of another embodiment and that the embodiments are not intended to limit the scope of the invention.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 depicts a simplified functional block diagram of electronic deposit box environment facilitated and managed by an electronic deposit box information handling system (IHS).

FIG. 2 depicts a communication diagram of the electronic deposit box environment of FIG. 1 with tenant IHS generating respective data structures that are secured by electronic deposit box IHS.

FIG. 3 presents a flow diagram of a method for securely storing personally identifiable information (PII) in an electronic deposit box.

### DETAILED DESCRIPTION

According to aspects of the present disclosure, an electronic deposit box platform is provided to answer this costly problem securely storing personal data and avoiding or mitigating liability for data theft. The electronic deposit box platform stores and protects PII, which is used by a company, by acting as a third party to separate companies from PII without interrupting the usability of their own property via a secure performant Application Programming Interface (API) protocol. Similar to the merchant service business model, this act of separation provides the following: (i) Liability and compliance overhead for PII storage is extracted away from the company. (ii) Security of PII storage is superior, protecting a company from outsider and insider threats of intent or error. Most data breaches are known to be caused by an insider error. (iii) PII interaction is seamless, performant, and will not hinder the transaction process. (iv) Consumers will have more confidence in a third-party curator whose business model is to comply with regulators to protect the consumer's PII.

The electronic deposit box platform makes data more secure by obfuscation and anonymization. Most databases are protected by only one encryption key. Most databases are organized in related tables, columns and fields with labels and names that build a map of where the valuable data is. If stolen, criminals can readily target where valuable data is located and decrypt the valuable data by breaking just one encryption key. By contrast, valuable data sent to the electronic deposit box platform by the company provides no indication where the valuable information is located, and the encryption is made more complex than a single encryption key by the electronic deposit box platform.

Cost of this service may mimic similar data storage costs per/Gb at cost efficient prices, thereby making the benefits of added security and liability mitigation a welcome byproduct of storing data with the electronic deposit box platform. The electronic deposit box platform stores encrypted account type data, such as a phone number or entire profile, but does not receive or store this data in a way that would identify the related natural person. The company, as the owner of the PII, is the only entity that can, from within its own system, relate a person to their personal data. This serves to mitigate the web company from PII storage liability as it is defined. The need for this service will continue to expand as the regulation expands and changes across states and countries.

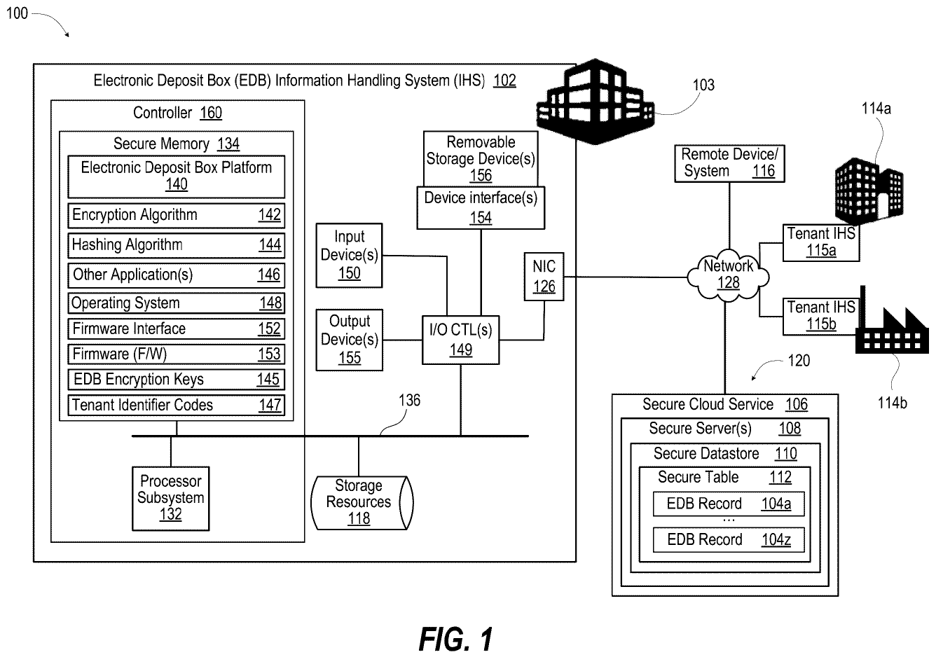

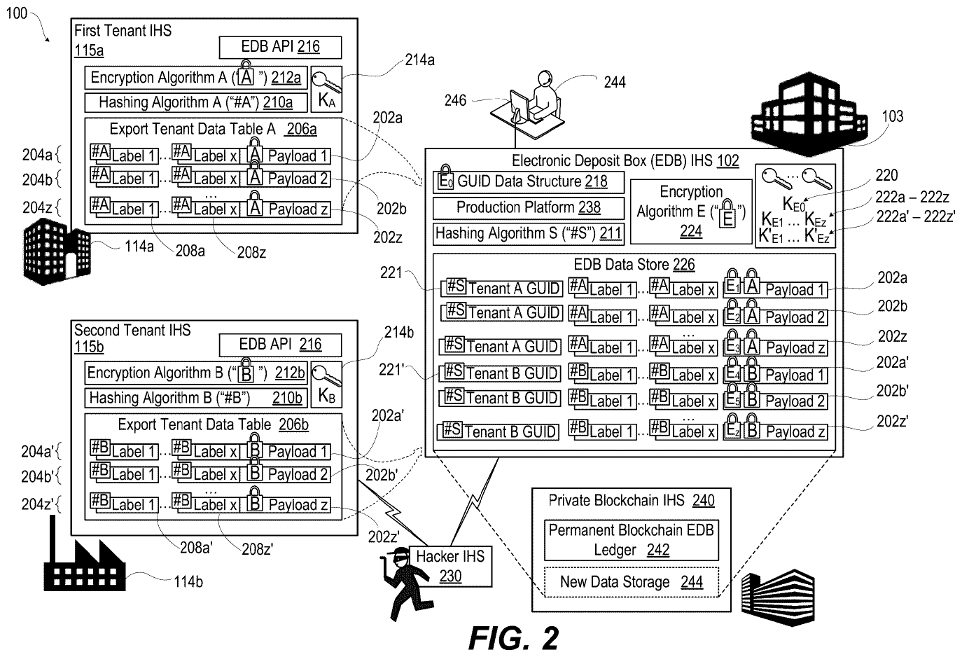

Turning to the Drawings, FIG. 1 depicts a simplified functional block diagram of an electronic deposit box electronic deposit box environment 100 facilitated and managed by an electronic deposit box (EDB) information handling system (IHS) 102 for abusiness 103. Electronic deposit box IHS 102 secures electronic deposit box records 104a-104z that reside in secure cloud service 106, within secure server(s) 108, in secure datastore 110, in secure table 112. Electronic deposit box environment 100 includes customers, which for clarity are depicted as two customers: first and second tenants 114a-114b that respectively use first and second tenant IHSs 115a-115b. In one or more embodiments, there may be only one customer. In one or more embodiments, there may be more than two customers. In one or more embodiments, a customer for secure data services may be one business entity of a particular enterprise and electronic deposit box IHS 102 may be another business entity of the same particular enterprise. For clarity, one electronic deposit box IHS 102 is depicted. However, electronic deposit box IHS 102 may be implemented in one or more data centers to dynamically shift workload and perform data recovery/backup functions. Functionality of electronic deposit box environment 100 may be largely automated with occasional updates and changes implemented via management consoles or other remote device systems 116. electronic deposit box environment 100 may include resources such as data storage resources 118 that are integral to electronic deposit box IHS 102. Electronic deposit box environment 100 may include third-party resources such as cloud storage system 106 that support electronic deposit box IHS 102. In one or more embodiments, cloud storage system 106 is hosted as part of private blockchain system 240 (See FIG. 2). In one or more embodiments, cloud storage system 106 may alternatively be hosted as part of public blockchain system 120

Within the general context of IHSs, IHS 102 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, IHS 102 may be a server, blade server, rack-mounted server, rack-mounted data storage, or other rack-mounted IT equipment. IHS 102 may include random access memory (RAM), one or more processing resources such as a central processing unit (CPU) or hardware or software control logic, read only memory (ROM), and/or other types of nonvolatile memory. Additional components of the IHS 102 may include one or more disk drives, one or more network ports for communicating with external devices as well as various input and output (I/O) devices, such as a keyboard, a mouse, and a video display. The IHS 102 may also include one or more buses operable to transmit communications between the various hardware components. In one or more embodiments, IHS 102 rack-mounted servers to provide computing, communication and storage functionality.

IHS 102 includes a network interface, depicted as network interface controller (NIC) 126. NIC 126 is communicatively connected to network 128. Remote device systems 116 are also communicatively connected to network 128. NIC 126 enables IHS 102 and/or components within IHS 102 to communicate and/or interface with other devices, services, and components that are located external to IHS 102. IHS 102 receives IHS updates and work requests from remote device systems 116 via network 128. These devices, services, and components can interface with IHS 102 via an external network, such as network 128, using one or more communication protocols that include transport control protocol (TCP/IP) and network block device (NBD) protocol. Network 128 can be a local area network, wide area network, personal area network, and the like, and the connection to and/or between network 128 and IHS 102 can be wired, wireless, or a combination thereof. For purposes of discussion, network 128 is indicated as a single collective component for simplicity. However, it should be appreciated that network 128 can comprise one or more direct connections to other devices as well as a more complex set of interconnections as can exist within a local area network or a wide area network, such as the Internet.

A processor subsystem 132 is coupled to secure memory 134 via system interconnect 136. Secure memory 134 is not accessible via network 128. System interconnect 136 can be interchangeably referred to as a system bus, in one or more embodiments. System interconnect 136 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus. For the purpose of this disclosure, system interconnect 136 can also be a Double Data Rate (DDR) memory interface. The secure memory 134 can either be contained on separate, removable dual inline memory module (RDIMM) devices or secure memory 134 can be contained within persistent memory devices (NVDIMMs). For example, the NVDIMM-N variety of NVDIMMs contain both random access memory, which can serve as secure memory 134, and non-volatile memory. It should be noted that other channels of communication can be contained within system interconnect 136, including but not limited to inter-integrated circuit (i2c) or system management bus (SMBus). System interconnect 136 communicatively couples various system components. Examples of system components include replaceable local storage resources 118 such as solid state drives (SDDs) and hard disk drives (HDDs). Software and/or firmware modules and one or more sets of data that can be stored on local storage resources 118 and be utilized during operations of IHS 102. Specifically, in one embodiment, secure memory 134 can include therein a plurality of such modules, including EpositBox electronic deposit box platform or application 140, EpositBox electronic deposit box encryption application 142, hashing application 144, other application(s) 146. Secure memory 134 can also store operating system (OS) 148, a firmware interface 152 such as basic input/output system (BIOS) or Uniform Extensible Firmware Interface (UEFI), and platform firmware (FW) 153. These software and/or firmware modules have varying functionality when their corresponding program code is executed by processor subsystem 132 or secondary processing devices within IHS 102. For example, other application(s) 146 may include Internet website hosting, a word processing application and a presentation application, among other applications. Secure memory 134 can include computer data structures and data values such as electronic deposit box encryption keys 145 and tenant identifiers (ID) codes 147 used by applications (140, 142, 144, 146).

IHS 102 further includes one or more input/output (I/O) controllers 148 that support connection by and processing of signals from one or more connected input device/s 150, such as a keyboard, mouse, touch screen, or microphone. I/O controllers 148 also support connection to and forwarding of output signals to one or more connected output devices 152, such as a monitor or display device or audio speaker(s). Additionally, in one or more embodiments, one or more device interfaces 154, such as an optical reader, a universal serial bus (USB), a card reader, Personal Computer Memory Card International Association (PCMCIA) slot, and/or a high-definition multimedia interface (HDMI), can be associated with IHS 102. Device interface(s) 154 can be utilized to enable data to be read from or stored to corresponding removable storage device/s 156, such as a compact disk (CD), digital video disk (DVD), flash drive, or flash memory card. In one or more embodiments, device interface(s) 154 can further include general purpose I/O interfaces such as inter-integrated circuit (I²C), system management bus (SMB), and peripheral component interconnect (PCI) buses.

In one or more embodiments, electronic deposit box IHS 102 is managed by controller 160 that configures electronic deposit box IHS 102 to perform functionality described herein. In one embodiment, controller 160 is processor subsystem 132 and secure memory 134. In one or more embodiments, controller 160 has a distributed architecture using a number of collaboratively functioning computing, storage, and communication components. In one or more embodiments, electronic deposit box IHS 102 is provisioned by a computer program product such as RSD 156 having a computer readable storage device such as physical memory that stores program code that, when executed by a hardware processor such as processor subsystem 132, configures IHS 102. The program code can include one or more modules described as being stored in secure memory 134. In an example, secure memory 134 stores electronic deposit box application 140, encryption application 142, and encryption key data structure that contains electronic deposit box encryption keys 145. A network interface such as NIC 126 is communicatively connectable, via network 128, to one or more tenant IHS 115a-115b that uses a respective hashing algorithm that hashes tabular labels and respective encryption algorithms that encrypts data payloads. Controller 160 is communicatively coupled to NIC 126 and secure memory 134.

FIG. 2 depicts a communication diagram of electronic deposit box environment 100 exchanging data structures generated by tenant IHSes 115a-115b and secured by electronic deposit box IHS 102. First tenant 114a has data that includes personally identifiable information (PII) in payloads 1-z 202a-202z to secure. First tenant IHS 115a prepares records 204a-204z in Export Tenant Data Table A 206a to convey payloads 1-z 202a-202z respectively associated with tabular labels 1-x 208a-208x. First tenant IHS 115a hashes tabular labels 1-x 208a-208x using Hashing Algorithm A 210a. Hashing Algorithm A 210a may be, for example, SHA-256, SHA-3-256, BLAKE2, BLAKE3, HMAC-SHA-256/HMAC-SHA-3 (keyed), or any cryptographically secure one-way hashing function selected and controlled by first tenant 114a. First tenant IHS 115a encrypts payloads 1-z 202a-202z using Encryption Algorithm A 212a and encryption key K_{A} 214a. Encryption Algorithm A 212a may be, for example, AES-256 (GCM, GCM-SIV, CBC with authentication), ChaCha20-Poly1305, XChaCha20-Poly1305, or any NIST or industry-recognized authenticated encryption scheme under exclusive first tenant 114a key control. Using electronic deposit box Application Program Interface (API) 216, first tenant 114a communicates export tenant data table “A” 206a to electronic deposit box IHS 102.

In one or more embodiments, electronic deposit box API 216 hashes a globally unique identifier (GUID) as an account identifier (ID) for a corresponding one of first and second tenant 114a-114b that is used to label Export Tenant Data table A 206a. The GUID is hashed using Hashing Algorithm S 211. Hashing Algorithm S 211 may be, for example, SHA-256, SHA-3-256, BLAKE2, BLAKE3, HMAC-SHA-256/HMAC-SHA-3 (keyed), or any cryptographically secure one-way hashing function. Electronic deposit box IHS 102 uses the hashed GUID for associating particular records with particular tenants 114a-114b. Use of hashed GUID obscures and makes anonymous the source of data to a data thief. GUID is a 128-bit unique reference number defined in RFC 4122 by the Internet Engineering Task Force (IETF). More complex unique reference identifiers (e.g. 256-bit, 512-bit, etc.), may also be used in some embodiments. GUIDs are used in computing as being highly unlikely to repeat when generated despite there being no central GUID authority to ensure uniqueness. GUIDs are also referred to as Universally Unique Identifiers (UUIDs) since there is no real difference between the two. A GUID follows a specific structure defined in RFC 4122 and come in a few different versions and variants. All variants follow the same structure xxxxxxxx-xxxx-Mxxx-Nxxx-xxxxxxxxxxxx where M represents the version and the most significant bits of N represent the variant.

EpositBox IHS 102 identifies the first tenant GUID for first tenant 114a included in tenant GUID data structure 218, which contains GUIDs for tenants of electronic deposit box IHS 102. Tenant GUID data store 218 is encrypted with Encryption Algorithm E 224 and encryption key K_{E0} 220. Encryption Algorithm E 224 may be, for example, AES-256 (GCM, GCM-SIV, CBC with authentication), ChaCha20-Poly1305, XChaCha20-Poly1305, or any NIST or industry-recognized authenticated encryption scheme. Electronic deposit box IHS 102 appends hashed first tenant ID GUID 221 on each record 204a-204z and over-encrypts each payloads 1-z 202a-202z using Encryption Algorithm E 224 using respective encryption keys K_{E1}-K_{Ez} 222a-222z. As used herein, “over-encrypting” means encrypting data two or more times, i.e. applying multiple layers of encryption, using multiple encryption algorithms and/or encryption keys. For example, in some embodiments, tenant IHS 115a encrypts payloads 1-z 202a-202z using Encryption Algorithm A 212a and encryption key “A” 214a and subsequently IHS 102 over-encrypts, i.e. encrypts a second time, each payloads 1-z 202a-202z using Encryption Algorithm E 224 using respective encryption keys K_{E1}- K_{Ez} 222a-222z. Encryption Algorithm E 224 may be, for example, AES-256 (GCM, GCM-SIV, CBC with authentication), ChaCha20-Poly1305, XChaCha20-Poly1305, or any NIST or industry-recognized authenticated encryption scheme. Each each record 204a-204z is stored in electronic deposit box Data Store 226. Tenant-hashed tabular labels 1-x 208a-208x are maintained in respective records 204a-204z for queries; however, electronic deposit box IHS 102 does not have information as to what the original tabular labels contained.

Similarly, second tenant 114b has data that includes PII in payloads 1-z 202a′ -202z′ to secure. Second tenant IHS 115b prepares records 204a′-204z′ in Export Tenant Data Table B 206b to convey payloads 1-z 202a′-202z′ respectively associated with tabular labels 1-x 208a′-208x′. Second tenant IHS 115b hashes tabular labels 1-x 208a′-208x′ using Hashing Algorithm B 210b. Hashing Algorithm B 210b may be, for example, SHA-256, SHA-3-256, BLAKE2, BLAKE3, HMAC-SHA-256/HMAC-SHA-3 (keyed), or any cryptographically secure one-way hashing function selected and controlled by second tenant 114b. Second tenant IHS 115b encrypts payloads 1-z 202a′-202z′ using Encryption Algorithm B 212b and encryption key K_{B} 214b. Encryption Algorithm B 212b may be, for example, AES-256 (GCM, GCM-SIV, CBC with authentication), ChaCha20-Poly1305, XChaCha20-Poly1305, or any NIST or industry-recognized authenticated encryption scheme under exclusive second tenant 114b key control. Using electronic deposit box API 216, second tenant 114b communicates Export Tenant Data Table B 206b to electronic deposit box IHS 102. Electronic deposit box IHS 102 identifies second tenant GUID included in encrypted tenant GUID data structure 218 that is encrypted with encryption key K′_{E0} 220. Electronic deposit box IHS 102 appends hashed second tenant ID GUID 221′ on each record 204a′-204z′ and over-encrypts each payloads 1-z 202a′-202z′ using Encryption Algorithm E 224 using respective encryption keys K′_{E1}-K′_{Ez} 222a′-222z′. Tenant-hashed tabular labels 1-x 208a-208x are maintained for queries; however, electronic deposit box IHS 102 and business 103 do not have information as to what the original tabular labels contained, what hashing algorithms, encryption algorithms, and encryption keys were used by the tenant IHSes 115a-115b. With data from multiple tenants interspersed with an anonymously hashed identifier, any decrypted PII is difficult to associate with any particular person or particular tenant 114a-114b, shielding particular tenants 114a-114b from liability. Electronic deposit box IHS 102 can find data for tenants 114a-114b using production platform 238 Hacker IHS 230 is presented with an insurmountable task to steal PII from electronic deposit box IHS 102.

In one or more embodiments, electronic deposit box IHS 102 uses private blockchain IHS 240 to create permanent blockchain electronic deposit box ledger 242 that is an immutable and auditable chain of record activity that prevents malicious interference with secured data. In one or more alternative embodiments, electronic deposit box IHS 102 may be configured to use a semi-private or public blockchain IHS 240 to create permanent blockchain electronic deposit box ledger 242. The blockchain ledger includes all activity related to the record. By database design, a record is ‘read-write-only’ and cannot be updated or deleted by electronic deposit box IHS 102 or the tenant. New data storage 244 is used to add data to permanent blockchain electronic deposit box ledger 242. To revise a previously secured record, a new record version is stored in new data storage 244 with reference to the previous record version included, indicating the change without deleting anything in permanent blockchain electronic deposit box ledger 242. No code is present in electronic deposit box IHS 102 capable of updating or deleting a record. In addition, all data is obfuscated by the customer before the data arrives at EpositBox making the data useless to all except the customer as the customer is the only entity that can reconstruct the record to its original form. Upon storage the customer's data is further obfuscated by the EpositBox platform, rendering it useless—even to the customer—until it is properly retrieved via the EpositBox platform. Thus, employee or agent 245 having access to electronic deposit box IHS 102 via management console 246 does not have authority to over-encrypt secured data as part of a ransom-ware attack since permanent blockchain electronic deposit box ledger 242 is immutable.

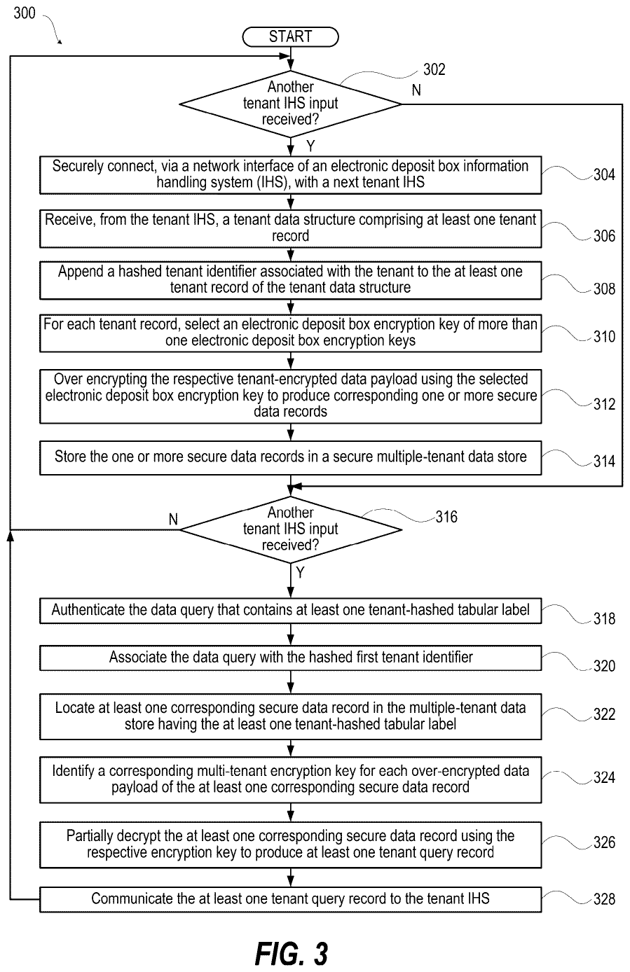

FIG. 3 presents a flow diagram of method 300 for securely storing PII in an electronic deposit box. Controller 160 of electronic deposit box IHS 102 (FIG. 1) may perform the functionality of method 300. Components described below for method 300 can be performed by like named components described above for FIGS. 1-2. Method 300 includes determining whether another tenant IHS input is received (decision block 302). In response to determining that another tenant IHS input is not received, method 300 proceeds to block 316. In response to determining that another tenant IHS input is received, method 300 includes securely connecting, via a network interface of an electronic deposit box information handling system (IHS), with a next tenant IHS (block 304). Method 300 includes receiving, from the tenant IHS, a tenant data structure comprising at least one tenant record (block 306). Each tenant record has one or more tenant-hashed tabular labels associated with a tenant-encrypted data payload. Method 300 includes appending a hashed tenant identifier associated with the tenant to the at least one tenant record of the tenant data structure (block 308). For each tenant record, method 300 includes selecting an electronic deposit box encryption key of one or more electronic deposit box encryption keys (block 310). In one or more embodiments, method 300 encrypts tenant records using the one or more selected electronic deposit box encryption keys. For example, in one or more embodiments, method 300 includes selecting a different electronic deposit box encryption key for each tenant record from among a plurality of electronic deposit box encryption keys, making malicious attempts to decrypt computationally impractical even for supercomputers. Method 300 includes over-encrypting the respective tenant-encrypted data payload using the selected electronic deposit box encryption key to produce corresponding one or more secure data records (block 312). Method 300 includes storing the one or more secure data records in a secure multiple-tenant data store (block 314).

In one or more embodiments, method 300 includes storing the one or more secure data records in the multiple-tenant data store in a database structured to permanently store the one or more secure data records. Method 300 includes revising a particular one of the one or more secure data records by storing a new data record with updated information while the original record remains. In one or more embodiments, method 300 includes permanently storing the one or more secure data records in blockchain storage. Electronic deposit box IHS 102 commits each secure data records as an append-only blockchain transaction containing at minimum the ciphertext plus integrity metadata, and the network's consensus finalizes the transaction into an immutable block such that rewriting prior history requires violating the consensus security assumptions. As used herein “permanent” means once committed and finalized, the record becomes non-overwritable and tamper-evident, with subsequent changes represented only as additional append transactions (e.g., update or “forgotten” tombstone events) rather than in-place modification.

After a no determination from decision block 302 or after block 314, method 300 includes determining whether another tenant IHS query is received (decision block 316). In response to determining that another tenant IHS query is not received, method 300 returns to block 302. In response to determining that another tenant IHS query is received, method 300 includes authenticating the data query that contains at least one tenant-hashed tabular label (block 318). Method 300 includes associating the data query with the hashed first tenant identifier (block 320). Method 300 includes locating at least one corresponding secure data record in the multiple-tenant data store having the at least one tenant-hashed tabular label (block 322). The electronic deposit box IHS performs locates at least one secure data record by comparing the received hashed values against stored hashed label tokens within the tenant's logical partition of the multi-tenant index. Because only hash equality is evaluated and all inputs are required to be non-reversible tokens, the electronic deposit box IHS can resolve record identifiers associated with matching hashes while remaining cryptographically blind to the tenant's original data.

Method 300 includes identifying a corresponding electronic deposit box encryption key for each over-encrypted data payload of the at least one corresponding secure data record (block 324). The electronic deposit box IHS identifies the corresponding electronic deposit box encryption key by reading key metadata bound to each ciphertext, then uses the tenant identifier and key identification to resolve the correct key handle from a key management domain and unwraps the envelope encryption, validating integrity before use.

Method 300 includes partially decrypting the at least one corresponding secure data record using the respective electronic deposit box encryption key to produce at least one tenant query record (block 326). The electronic deposit box IHS applies a second-layer unwrap/decrypt using a platform key before the tenant-layer decryption, with the key hierarchy and versions deterministically selected from the metadata and policy.

Each tenant query record has the one or more tenant-hashed tabular labels associated with the tenant-encrypted data payload. Method 300 includes communicating the at least one tenant query record to the first tenant IHS (block 328). Then method 300 returns to block 302.

It will be apparent to those skilled in the art that various modifications and variations can be made to the disclosed system. Other examples will be apparent to those skilled in the art from consideration of the specification and practice of the disclosed system. It is intended that the specification and examples be considered as illustrative only, with a true scope being indicated by the following claims and their equivalents.

What is claimed is:

1. A deposit information handling system (IHS) comprising:
a network interface communicatively connectable, via a network, to one or more tenant IHS, the one or more tant IHS including a first tenant IHS, the first tentnat IHS configured to use a first tenant hashing algorithm that hashes tabular labels and a first tenant encryption algorithm that encrypts data payloads with a first tenant encryption key;
a secure memory that stores a deposit application, an deposit encryption application, and a deposit encryption key data structure; and
a controller communicatively coupled to the network interface and the secure memory, the controller comprising at least one hardware processor that executes the deposit application to configure the deposit IHS, and which:
securely connects, via the network interface, with the first tenant IHS;
receives, from the first tenant IHS, a first tenant data structure comprising at least one first tenant record, each tenant record including a first tenant-hashed tabular label associated with a first tenant-encrypted data payload;
appends a first tenant identifier associated with the first tenant to the at least one first tenant record of the first tenant data structure;
selects an deposit encryption key of one or more deposit encryption keys stored on the secure memory;
over-encrypts the respective first tenant-encrypted data payload using the selected deposit box encryption key to produce a first tenant secure data record; and
stores the first tenant secure data record in a multiple-tenant data store.

2. The deposit box IHS of claim 1, wherein the controller:
selects a different deposit encryption key of the more than one deposit encryption keys for each first tenant record.

3. The deposit IHS of claim 1, wherein the controller:
securely connects, via the network interface, with a second tenant IHS of the one or more tenant IHS, the second tenant IHS using a second tenant hashing algorithm that hashes tabular labels and a second tenant encryption algorithm that encrypts data payloads with a second tenant encryption key;
receives, from the second tenant IHS, a second tenant data structure comprising at least one second tenant record, each second tenant record having one or more second tenant-hashed tabular labels associated with a second tenant-encrypted data payload;
hashes a second tenant identifier associated with the second tenant;
appends the hashed second tenant identifier to the at least one second tenant record of the second tenant data structure;
selects another deposit encryption key of the one or more deposit encryption keys stored on the secure memory;
over-encrypts the second tenant-encrypted data payload using the selected deposit encryption key to produce a second tenant secure data record; and
stores the second tenant secure data record in the multiple-tenant data store.

4. The deposit IHS of claim 1, wherein the controller:
in response to receiving a data query from the first tenant IHS:
authenticates the data query that contains at least one first tenant-hashed tabular label;
associates the data query with the first tenant identifier;
locates at least one corresponding secure data record in the multiple-tenant data store having the at least one first tenant-hashed tabular label;
identifies a corresponding deposit encryption key for each over-encrypted first tenant data payload of the at least one corresponding secure data record;
partially decrypts the at least one corresponding secure data record using the respective deposit encryption key to produce a first tenant query record, the first tenant query record having the one or more first tenant-hashed tabular labels associated with the first tenant-encrypted data payload; and
communicates the first tenant query record to the first tenant IHS.

5. The deposit IHS of claim 1, wherein the controller:
stores the first tenant secure data records in the multiple-tenant data store in a database structured to permanently store the first tenant secure data record; and
revises the first tenant secure data record by storing a new data record with updated information.

6. The deposit IHS of claim 5, wherein the controller permanently stores the one or more secure data record in blockchain storage.

7. A method comprising:
securely connecting, via a network interface of a deposit information handling system (IHS), with a first tenant IHS;
receiving, from the first tenant IHS, a first tenant data structure comprising at least one first tenant record, each first tenant record including a first tenant-hashed tabular label associated with a first tenant-encrypted data payload;
appending a first tenant identifier associated with the first tenant to the at least one first tenant record of the first tenant data structure;
selecting an deposit encryption key of one or more deposit encryption keys stored on the deposit IHS;
over-encrypting the first tenant-encrypted data payload using the selected deposit encryption key to produce a first tenant secure data record; and
storing the first tenant secure data record in a secure multiple-tenant data store.

8. The method of claim 7, further comprising selecting a different deposit encryption key of the more than one deposit encryption keys for each first tenant record.

9. The method of claim 7, further comprising:
securely connecting, via the network interface, with a second tenant IHS of the one or more tenant IHS, the second tenant IHS using a second tenant hashing algorithm that hashes tabular labels and a second encryption tenant algorithm that encrypts data payloads with a second tenant encryption key;
receiving, from the second tenant IHS, a second tenant data structure comprising at least one second tenant record, each second tenant record having one or more second tenant-hashed tabular labels associated with a second tenant-encrypted data payload;
appending a second tenant identifier associated with the second tenant to the at least one second tenant record of the second tenant data structure;
selecting another deposit encryption key of the one or more deposit encryption keys;
over-encrypting the second tenant-encrypted data payload using the selected deposit encryption key to produce a second tenant secure data record; and
storing the second tenant one or more secure data record in the multiple-tenant data store.

10. The method of claim 7, further comprising:
in response to receiving a data query from the first tenant IHS:
authenticating the data query that contains at least one first tenant-hashed tabular label;
associating the data query with the first tenant identifier;
locating at least one corresponding secure data record in the multiple-tenant data store having the at least one first tenant-hashed tabular label;
identifying a corresponding deposit encryption key for each over-encrypted first tenant data payload of the at least one corresponding secure data record;
partially decrypting the at least one corresponding secure data record using the respective deposit encryption key to produce at least one first tenant query record, each first tenant query record having the one or more first tenant-hashed tabular labels associated with the tenant-encrypted data payload; and
communicating the first tenant query record to the first tenant IHS.

11. The method of claim 7, further comprising:
storing the first tenant secure data record in the multiple-tenant data store in a database structured to permanently store the first tenant secure data record; and
revising first tenant data record by storing a new data record with updated information.

12. The method of claim 11 further comprising permanently storing the secure data record in blockchain storage.

13. A computer program product comprising:
a computer readable storage device; and
program code on the computer readable storage device that when executed by a processor associated with a deposit information handling system (IHS), the program code enables the IHS to provide functionality of:
securely connecting, via a network interface of the deposit IHS, with a first tenant IHS;
receiving, from the first tenant IHS, a first tenant data structure comprising at least one first tenant record, each first tenant record including a first tenant-hashed tabular label associated with a tenant-encrypted data payload;
appending a first tenant identifier associated with the first tenant to the at least one tenant record of the first tenant data structure;
selecting an deposit encryption key of one or more deposit encryption keys stored on the deposit box IHS;
over-encrypting the first tenant-encrypted data payload using the selected deposit encryption key to produce a first tenant secure data record; and
storing the first tenant secure data record in a secure multiple-tenant data store.

14. The computer program product of claim 13, wherein the program code enables the IHS device to provide the functionality of selecting a different deposit encryption key of deposit encryption keys for each first tenant record.

15. The computer program product of claim 13, wherein the program code enables the deposit box IHS to provide the functionality of:
securely connecting, via the network interface, with a second tenant IHS of the one or more tenant IHS, the second tenant IHS using a second tenant hashing algorithm that hashes tabular labels and a second tenant encryption algorithm that encrypts data payloads with a second tenant encryption key;
receiving, from the second tenant IHS, a second tenant data structure comprising at least one tenant record, each second tenant record having one or more second tenant-hashed tabular labels associated with a second tenant-encrypted data payload;
appending a second tenant identifier associated with the second tenant to the at least one second tenant record of the second tenant data structure;
selecting another deposit encryption key of the deposit encryption keys;
over-encrypting the second tenant-encrypted data payload using the selected deposit encryption key to produce a second tenant secure data record; and
storing the second tenant secure data record in the multiple-tenant data store.

16. The computer program product of claim 13, wherein the program code enables the deposit box IHS to provide the functionality of:
in response to receiving a data query from the first tenant IHS:
authenticating the data query that contains at least one first tenant-hashed tabular label;
associating the data query with the first tenant identifier;
locating at least one corresponding secure data record in the multiple-tenant data store having the at least one first tenant-hashed tabular label;
identifying a corresponding deposit encryption key for each over-encrypted data payload of the at least one corresponding secure data record;
partially decrypting the at least one corresponding secure data record using the respective deposit encryption key to produce at least one first tenant query record, each first tenant query record having the one or more first tenant-hashed tabular labels associated with the tenant-encrypted data payload; and
communicating the at least one first tenant query record to the first tenant IHS.

17. The computer program product of claim 13, wherein the program code enables the deposit IHS to provide the functionality of:
storing the first tenant secure data record in the multiple-tenant data store in a database structured to permanently store the first tenant secure data record; and
revising a particular one of the first tenant secure data record by storing a new data record with updated information.

18. The computer program product of claim 17, wherein the program code enables the deposit IHS to provide the functionality of permanently storing the secure data record in blockchain storage.

19. The deposit IHS of claim 1, wherein the deposit IHS does not receive the first tenant encryption key and the secure memory does not store the first tenant encryption key.

20. The deposit IHS of claim 1, wherein the first tenant data structure does not include the original contents of the first tenant-hashed tabular label before the first tenant-hashed tabular label was hashed.
